(19) United States
(12) Patent Application Publication
(10) Pub. No.: US 2007/0244668 A1
(43) Pub. Date: Oct. 18, 2007

(54) Measured-value acquisition device

(75) Inventor: Ralf Huck, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/783,080

(22) Filed: Apr. 5, 2007

(30) Foreign Application Priority Data
Apr. 18, 2006 (DE) 10 2006 018 174.3

(51) Int. Cl. G06F 17/40; G06F 19/00

(52) U.S. Cl. 702/187; 702/188; 702/189; 702/1; 702/33; 702/127

(57) ABSTRACT

The disclosure relates to a measured-value acquisition device for measuring physical values of a technical process in a process engineering system, for converting the physical value into an adequate electrical value and outputting the latter to a communications medium. For the flexible acquisition of a plurality of measurement signals with the least possible installation effort, it is proposed that the function group for measured-value acquisition and the function group for measured-value processing are physically separate from one another and can be logically connected to one another via a wireless communications link, that the function group for measured-value processing is connected via a conductor loop to a superordinate device, in which the power can be supplied and the measurement information can be transmitted over the same pair of wires, and that the function group for measured-value acquisition can be arranged directly at the measuring site and can have a local power supply.

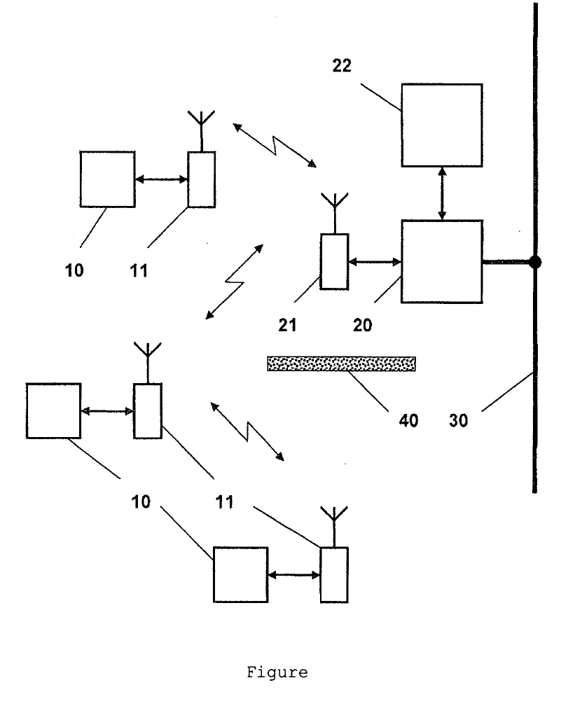

### RELATED APPLICATIONS

This application claims priority under 35 U.S.C. §119 to German Application 10 2006 018 174.3 filed in Germany on Apr. 18, 2006, the entire contents of which are hereby incorporated by reference in their entireties.

### TECHNICAL FIELD

The disclosure relates to a measured-value acquisition device for measuring physical values of a technical process in a process engineering system, for converting the physical value into an adequate electrical value and outputting the latter to a communications medium.

### BACKGROUND INFORMATION

In automation technology, measurement devices are usually equipped with digital signal processing, that is to say realized with the aid of A/D or D/A converters to record or output analog values, and microcontrollers.

In the case of field devices, by and large 2-conductor technology has become the established method of signal transmission, in which the power is supplied and the measurement information is transmitted over the same pair of wires. Only the measuring methods that require a higher level of power have a separate power input. In this case this is referred to as 4-conductor technology, since the signals are transmitted and the power is supplied over separate pairs of wires. In both cases, the signal transmission may be an analog, usually 4.20 mA signal, or a digital field bus signal. The combination, that is to say the overlaying of digital information over the analog signal, is also known as HART communication.

It is furthermore known to loop an indicator into the 4.20 mA signal of a loop-fed analog device. The indicator can then be installed at any point in the system. Using specially designed indicators that also support the HART protocol, in addition to evaluating and displaying the measurement signal it is also possible to perform local parameterization of the analog device.

In all the applications described, the desired functionality is always realized in one unit. The conditioning of a measured value, or a plurality of measured values in the case of multi-channel devices, is thus always assigned to exactly one processing unit. Where it is necessary to acquire a plurality of measured values at different sites, either multi-channel units or a plurality of single-channel units are used. In all cases here, an electrical connection for transmitting information and power must be established between all subscribers. If greater availability is required, further electrical connections are required for redundant information and power transmission. Overall the cabling constitutes a high outlay, and is also very inflexible because of being bound to a locality.

It is furthermore known from the publication “Das drahtlose Sensornetz” [The Wireless Sensor Network], published in Sensor Guide 2005, Computer & Automation, pages 14 to 18, that the signals of a processing unit can also be transmitted via radio. The power supply of the processing unit can then either be by means of wires or from a local power source, for example in the form of a battery or fuel cell. The service intervals of the variant with a local power source are here directly dependent on the local power consumption and the capacity of the power source. However, the power consumption of the processing units required in the process industry is often so great that wireless systems cannot consequently be realized and only with very short service intervals—for changing the batteries.

### SUMMARY

The disclosure helps to realize the acquisition, as flexibly as possible, of a plurality of measurement signals with the least possible installation effort and long service intervals.

The disclosure is based on the finding that known measurement devices have an internal structural modularity, where function groups for measured-value acquisition and measured-value processing that act largely independently of one another interoperate in an application-related unit. The function group for measured-value acquisition here encompasses the conversion of the physical value into an adequate electrical value, the signal amplification and the digitization of the measured value. A raw value of the measured value can be provided at the output of the function group for measured-value acquisition.

The function group for measured-value processing encompasses the complete conditioning of the raw value of the measured value obtained from the function group for measured-value acquisition, including linearization and calibration, as well as the communication of the measurement device with a requesting, superordinate device. If the measurement device is equipped with local control and display devices, the function group for measured-value processing is responsible for their control.

According to one aspect of the disclosure, the function group for measured-value acquisition and the function group for measured-value processing are physically separate from one another and can be logically connected to one another via a wireless communications link. The function group for measured-value processing is connected here via a conductor loop to a superordinate device, in which the power can be supplied and the measurement information can be transmitted over the same pair of wires. The function group for measured-value acquisition can be arranged directly at the measuring site and can have a local power supply.

As a result of being able to dispense with the cable connection to the function group for measured-value acquisition, its physical arrangement can be adapted freely and flexibly to the requirements of the measuring task. The installation effort can be limited to the installation of the function group for measured-value acquisition at the measuring site.

In comparison with the power requirement of the overall measurement device, the power requirement of the function group for measured-value acquisition can be so small that the local power supply can advantageously be realized by means of batteries with long service intervals.

According to a further aspect of the disclosure, it is provided that a plurality of remotely arranged function groups for measured-value acquisition are assigned to a function group for measured-value processing. It is advantageous here to use only a single function group for measured-value processing to acquire a plurality of measured values, and accordingly also only one conductor loop is required for supplying power to the function group for measured-value processing and for communicating with the superordinate device. As a consequence, the installation effort can be reduced in inverse proportion to the number of measuring sites that are operated via the same function group for measured-value processing.

According to a further aspect of the disclosure, it is provided that a device for local power generation is assigned to the function group for measured-value acquisition. The battery as a local energy store can be advantageously accorded only a backup function in the event of a fault or interruption of the primary power supply. As a result, a further extension of the service intervals can be achieved.

According to a further aspect of the disclosure, a wireless communications link is provided between the function groups for measured-value acquisition. As a result of this, communication obstacles between the function group for measured-value processing and one of the function groups for measured-value acquisition can be advantageously overcome. Consequently, flexibility in the selection of the measuring sites can be further increased. In addition, the availability of such a redundant system can be increased and the system can be more robust with respect to faults.

### BRIEF DESCRIPTION OF THE DRAWING

The invention is explained in greater detail below with reference to various exemplary embodiments. An exemplary measured-value acquisition device is illustrated in the single FIGURE.

### DETAILED DESCRIPTION

In the simplest exemplary embodiment, the measured-value acquisition device comprises a function group for measured-value acquisition 10 and a function group for measured-value processing 20 which are physically separate from one another and can be logically connected to one another via a wireless communications link 11, 21. For this purpose a communications terminal 11 can be assigned to the function group for measured-value acquisition 10 and a communications link 21 can be assigned to the function group for measured-value processing 20.

The function group for measured-value processing 20 is connected to a field bus 30. The function group for measured-value processing 20 communicates with a superordinate device via the field bus 30. The function group for measured-value processing 20 can be advantageously supplied with power via the field bus 30 here. In addition, a control and display device 22 can be assigned to the function group for measured-value processing 20.

The function group for measured-value acquisition 10 here encompasses the conversion of a physical value into an adequate electrical value, the signal amplification and the digitization of the measured value. A raw value of the measured value can be provided at the output of the function group for measured-value acquisition 10 and can be forwarded over the wireless communications link 11, 21 to the function group for measured-value processing 20.

The function groups for measured-value acquisition 10 can be located close to the process at the measuring site. In this arrangement, each function group for measured-value acquisition 10 can be supplied with power locally.

In another exemplary embodiment, a battery is provided as the power source for supplying power to the function groups for measured-value acquisition 10. As a result of the limited functionality of the function groups for measured-value acquisition 10, their power consumption can be so low that they can be supplied by a battery, and with long service intervals.

Connected to a wireless transmission, the function groups for measured-value acquisition 10 can now be incorporated in the measured-value acquisition device completely wirelessly. This greatly simplifies their installation close to sensors.

In yet another exemplary embodiment, a device for local power generation is assigned to the function group for measured-value acquisition 10. In this case provision may be made to utilize a primary energy that can be used in the process, such as compressed air for example, the flow energy of which is converted into electrical energy by means of a turbine and a generator. Alternatively, natural primary energy sources, such as sunlight for example, may be used with means for conversion into electrical energy that are known per se. The person skilled in the art will choose a suitable form depending on the primary energy available at the measuring site.

The primary energy supply can be expediently backed up by a battery for bridging breaks in supply or power failures. As a consequence, it is expediently possible to dispense with supply-related maintenance, such as would be required for changing batteries.

The function group for measured-value processing 20 encompasses the complete conditioning of the raw value of the measured value obtained from the function group for measured-value acquisition 10, including linearization and calibration, as well as the communication of the measurement device with a requesting, superordinate device via the field bus 30. In addition, the function group for measured-value processing 20 is responsible for controlling the control and display device 22.

Depending on the type of measured-value acquisition device, further inputs/outputs for local control may be provided, which are then also controlled and operated by the function group for measured-value processing 20.

In yet another exemplary embodiment, it is provided that two or more function groups for measured-value acquisition 10 are assigned to a function group for measured-value processing 20. In this version too, the overall functionality can be performed by the sum of the separated units. It is however advantageous that the function groups for measured-value acquisition 10 may simply be located in the vicinity of the measuring site and that, despite the local installation of said units, only a single function group for measured-value processing 20 is ever required. This has a beneficial effect on the total power consumption.

All power-hungry functions such as, for example, the HART or field bus communications, which require computing power for the signal processing and calibration or the control of a display with backlighting, can be reserved for the function group for measured-value processing 20. The function group for measured-value processing 20 can be located at any point in the vicinity of the function groups for measured-value acquisition 10. Its power can be advantageously provided here via the loop-fed HART or field bus communication.

In yet another exemplary embodiment, a wireless communications link is provided between the function groups for measured-value acquisition 10. In this case, one or more function groups for measured-value acquisition 10 always communicates with the function group for measured-value processing 20 via at least one further function group for measured-value acquisition 10. As a result of this, obstacles 40 that interfere with the direct communication between the function group for measured-value processing 20 and one of the function groups for measured-value acquisition 10 can be advantageously overcome. Consequently, flexibility in the selection of the measuring sites can be further increased. In addition, the availability of such a redundant system can be increased and the system can be more robust with respect to faults.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

### 10 Measured-value acquisition

### 11 Communications terminal

### 20 Measured-value processing

### 21 Communications terminal

### 22 Control and display device

### 30 Field bus

40 Obstacle

What is claimed is:

1. Measured-value acquisition device for measuring physical values of a technical process in a process engineering system, for converting the physical value into an adequate electrical value and outputting the latter to a communications medium comprising a function group for measured-value acquisition and a function group for measured-value processing, wherein
the function group for measured-value acquisition and the function group for measured-value processing are physically separate from one another and are logically connected to one another via a wireless communications link,
the function group for measured-value processing is connected via a conductor loop to a superordinate device, in which the power is supplied and the measurement information is transmitted over the same pair of wires, and
the function group for measured-value acquisition is arranged directly at the measuring site and has a local power supply.

2. Measured-value acquisition device as claimed in claim 1, wherein
a plurality of remotely arranged function groups for measured-value acquisition are assigned to a function group for measured-value processing.

3. Measured-value acquisition device as claimed in claim 2, wherein
a wireless communications link is provided between the function groups for measured-value acquisition.

4. Measured-value acquisition device as claimed in claim 1, wherein
a device for local power generation is assigned to the function group for measured-value acquisition.

5. Measured-value acquisition device for measuring physical values of a technical process at a measuring site, comprising:
a function group for measured-value acquisition; and
a function group for measured-value processing logically connected to the function group for measured-value acquisition via a wireless communications link, wherein
the function group for measured-value processing is connected via a conductor loop to a superordinate device, in which the power is supplied and the measurement information is transmitted, and wherein the function group for measured-value acquisition is locally powered and arranged at the measuring site.
